(19) United States
(12) Patent Application Publication
(10) Pub. No.: US 2005/0117018 A1
(43) Pub. Date: Jun. 2, 2005

(54) Automated camera system

(76) Inventor: Peter H. Wolf, Thousand Oaks, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 11/008,697

(22) Filed: Dec. 8, 2004

Related U.S. Application Data
(63) Continuation-in-part of application No. 09/641,248, filed on Aug. 17, 2000.
(60) Provisional application No. 60/554,980, filed on Mar. 19, 2004.
(60) Provisional application No. 60/163,879, filed on Nov. 5, 1999.

(51) Int. Cl. H04N 9/47

(52) U.S. Cl. 348/143

(57) ABSTRACT

An automated camera system for use during a sporting event includes at least one remote camera module positioned along a course or field of a sporting event. Each remote camera module includes a still photograph camera and a trigger device. Camera optical characteristics and orientation can be adjusted based on commands received from a user command center in electronic communication with the remote camera modules.

### RELATED APPLICATION

This application claims priority to U.S. Provisional Application No. 60/554,980, filed on Mar. 19, 2004; and is a continuation-in-part application of U.S. Utility Application Ser. No. 09/641,248, filed Aug. 17, 2000 which claimed priority to U.S. Provisional Application No. 60/163,879, filed Nov. 5, 1999.

### BACKGROUND OF THE INVENTION

The present invention generally relates to event photography, and particularly sporting event photography. More particularly, the present invention relates to an automated camera system for use during a sporting event using one or more remote camera modules positioned along a course or field of a sporting event and controlled by as few as a single operator.

Sporting events such as marathons, triathlons, and bicycling events are held on nearly every weekend of the year across the nation, particularly during the summer months. It is reasonable to assume that at least one major event with ten thousand or more participants is held on any given weekend somewhere within the United States. Several events with five thousand or more participants are likely to be held throughout the United States on any given weekend. Events with two thousand participants are probably held in at least twenty locations across the United States on any given weekend.

It is a common practice for event photographers to obtain contracts to photograph such events and provide photos for sale to the event participants after the event is concluded. In the past, photographers have been positioned throughout the course of the sporting event, such as at the starting line, finish line, and at key or particularly picturesque locations along the course or field of the sporting event. For example, in a triathlon photographers would be positioned at at least one location of the swimming leg, the running leg, and the bicycling leg as well as the finish line of the race. The larger the race, the more photographers are needed to photograph the large number of participants in that sporting event. Assistants often aid the photographer by loading film into extra cameras so that the photographer can devote his or her time to capturing photographs of as many participants as possible. Those skilled in the art will appreciate that the labor costs associated with such events due to the number of photographers and assistants is burdensome.

Each photographer can take hundreds or even thousands of pictures during the course of the several hours of the sporting event. Consistent performance of the photographer is a problem. The weak link in nearly all photography applications is the photographer. A proficient photographer will be able to capture some number of flawless pictures, but over a period of hours, the body, fingers and eyes become tired and prone to error.

Another problem with human photographers is that nearly all of the pictures are taken in nearly the same perspective, that is at approximately the same height as the sporting event participant. It is often dangerous, if not impossible, for photographers to be positioned at angles of interest, such as on the scaffolding of the finish line, etc.

The traditional process of offering the photographs to the sporting event participants is also costly and problematic. Traditionally, event photographs taken along the event route or finish line are developed and scrutinized for identifying markings, such as “bib numbers” of event participants. The name and mailing address of the event participants who are identifiable by their bib number markings are then cross-checked to a roster that lists all the event participants, their bib or identification numbers and their addresses. A thumbnail photographic image of the identified event participant is then printed and mailed to the participant along with an order form that needs to be filled out by the event participant and then transmitted back to the photographer by mail, fax, etc. Upon receipt of the order form, the photographer then develops or produces the requested photograph and mails it back to the event participant to complete the transaction. This method requires several weeks or even months of time and is costly due to the labor involved in analyzing and cross-checking the photographs and event participant listings, the developing of the thumbnail pictures, and the multiple mailings between the photographer and the event participants. Some event participants are not offered the option of purchasing photographs because the identifying bib number markings are not visible in the photographs. This can be due to the bib number being improperly attached to the event participant or lost along the event route, or due to the angle the photograph was taken or a participant obscuring the markings of another.

Accordingly, there is a continuing need for an automated camera system for use during a sporting event. Such an automated system should eliminate the need for multiple photographers and assistants. Such an automated camera system should be capable of being used at multiple positions along a sporting event course or field so as to take a great number of pictures of the participants. Such an automated camera system should also incorporate a less costly and easier to search methodology for finding and ordering photographs of the event. The present invention fulfills these needs and provides other related advantages.

### SUMMARY OF THE INVENTION

The present invention resides in an automated camera system which replaces human photographers and allows photography in places where it would be impractical or inaccessible for a human photographer. The system of the present invention also provides a practical and cost-effective method of searching and ordering photographs of the event participants.

The automated camera system of the present invention generally comprises a plurality of remote camera modules positioned along a course or field of the sporting event. Each remote camera module comprises a still photograph camera and a device for triggering the camera. In a particularly preferred embodiment, the camera comprises a digital camera and the module includes an electronic storage medium for storing digital images from the camera.

Preferably, the remote camera module includes a flash device, wherein the triggering device activates the flash device and the camera. The triggering device may be light activated. Such a triggering device comprises a light-impermeable housing having a polarizing light filter an iris or other means of limiting the amount of light, positioned within the housing. A lens disposed within the housing focuses light onto a transducer. A passive trigger signal is generated when light is reflected into the photo sensor. Alternatively, upon disruption of received light an active trigger signal is generated.

In a particularly preferred embodiment, each remote camera module is in communication with a central user command center. Thus, each remote camera module comprises means for communicating with the command center, such as an antenna operably connected to a controller of the module for adjusting camera optical characteristics or camera orientation based on commands received from the user command center. Typically, the controller comprises a computer.

The means for adjusting the camera orientation typically include a gear assembly operably connected to a motor which adjusts the camera orientation. The controller is also adapted to control optical characteristics of the camera, such as f-stop, angle, focus, power on/off, trigger on/off, and shutter speed of the camera. Each remote camera module includes a power source, such as a battery. Each remote camera module also typically includes means for protecting electronic components thereof from ambient environmental conditions.

In a particularly preferred embodiment, each digital image taken by the digital camera includes date and time indicia associated therewith. The digital images are downloaded to a web-site where they can be searched according to the date and time indicia, and subsequently ordered.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an environmental view of the automated camera system of the present invention used in a triathlon race;

FIG. 2 is a perspective view of a remote camera module embodying the present invention;

FIG. 3 is a perspective view of a pair of remote camera modules used in the course of the present invention being activated by a sensor to photograph a sporting event participant;

FIG. 4 is a diagrammatic view illustrating component parts of the remote camera module;

FIG. 5 is a diagrammatic view of the remote camera system having multiple remote camera modules in accordance with the present invention;

FIG. 6 is a diagrammatic view illustrating the invention used to photograph a sporting event participant at a finish line of a sporting event; and

FIG. 7 is a diagrammatic view of a single remote camera module having a camera positionable to capture sporting event participants at different points of a sporting event.

### DETAILED DESCRIPTION OF THE PREFERRED EMBODIMENTS

As shown in the accompanying drawings for purposes of illustration, the present invention resides in an automated remote camera system which is particularly adapted for use in sporting events and the like, such as triathlons, marathons, bicycle races, etc. The automated camera of the present invention replaces human photographers and allows photography in places where it would be impractable or inaccessible for a human photographer.

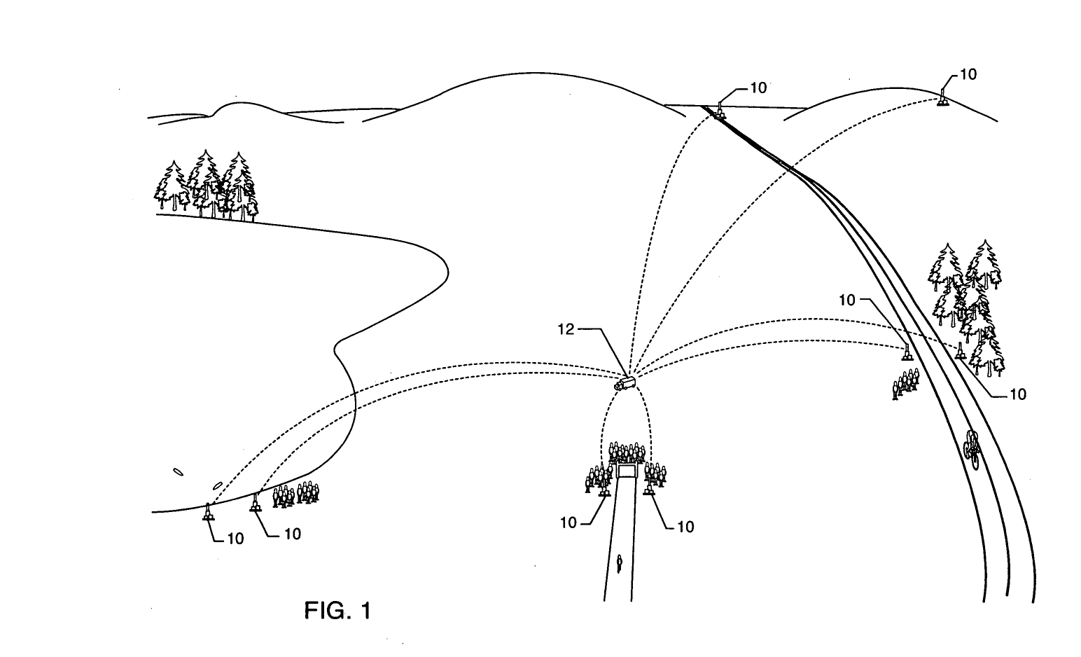

With reference now to FIG. 1, the system of the present invention includes a plurality of remote camera modules 10 positioned along a course or field of the sporting event, in this case a triathlon. In a particularly preferred embodiment, a user command center 12 is in electronic communication with the remote camera module 10 for monitoring, and if necessary controlling, each remote camera module 10, as will be more fully discussed herein. The user command center 12 can be manned by as few as a single operator which can control a plurality of the remote camera modules 10. Although the remote camera module 10 can be electronically connected to the user command center 12 by any means, typically the communication between the user command center 12 and the remote camera module 10 is wireless such as, by using a radio frequency signal, satellite signal, etc. This is due to the fact that the remote camera module can be placed hundreds of yards or even miles away from the user command center 12, and thus encompass the entire sporting event course.

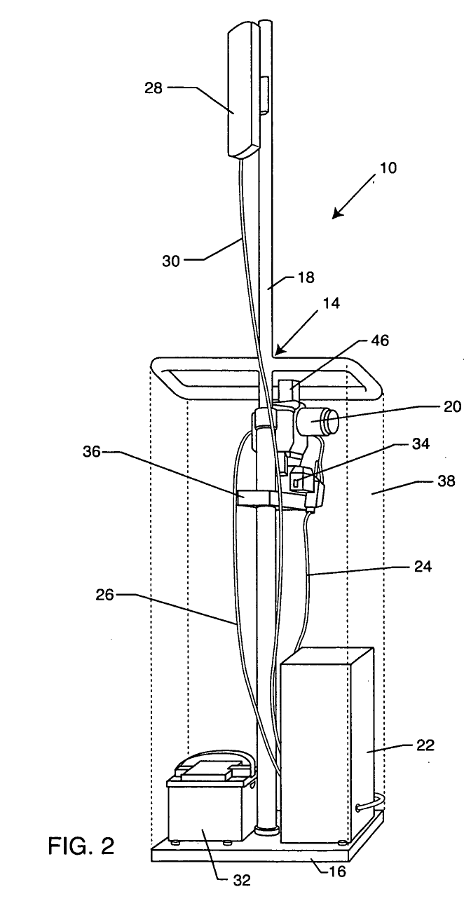

With reference now to FIG. 2, a particularly preferred remote camera module embodying the present invention is illustrated. Typically, the module 10 includes framework 14 extending from a base 16 for supporting the various components of the camera module 10 thereon. The framework 14 typically includes a mast 18 which extends upwardly from the base 16 and allows a camera 20 of the module 10 to be positioned at varying selected heights. Preferably, the base 16 is adjustable so as to be capable of being leveled with respect to uneven ground, such as on an outdoor playing field, roadside, etc. Such level adjustment means can comprise individual feet underlying the base 16 and adjustable by thumb screws or the like (not shown).

Each remote camera module 10 includes a still photography camera 20. In a particularly preferred embodiment, the camera 20 comprises a digital camera having the remote control capability, such as the Nikon D1. The controller 22, typically a computer, is electronically connected to the camera 20, such as via cable 24 which can comprise a camera firewire cable. A camera power supply cable 26 provides power to the camera 20. The controller 22 receives commands from the user command center 12, such as via antenna 28 fixed to the mast 18 of the framework 14 and electronically connected to the controller 22. Controller 22, responding to the user command center 12 command, is capable of turning the camera 20 on and off, adjusting the f-stop, focus, shutter speed, and other camera optical characteristics deemed necessary to capture the best photograph of the sporting event participants through a communication cable 30.

The remote camera module 10 requires a power source 32. Such a power source 32 can comprise an electrical outlet or an electric generator. More typically, the power source 32 comprises a battery such as the 12-volt battery illustrated in FIG. 2. Of course, it would be appreciated by those skilled in the art that the controller 22 can include a 12 volt DC or 120 volt AC switch (DPDT) to accommodate either power source. In the instance where the 12 volt DC battery 32 is used, the controller 22 includes a 12 volt DC to 120 volt AC inverter to power the computer and electronics within the controller 22. A different inverter may be used to power the camera 20, or the camera 20 can have its own power source. For safety and security purposes, the electronic components of the controller 22 are typically disposed within a sturdy housing, such as metal box or the like.

In a particularly preferred embodiment, a remote control module can also include means for adjusting the camera 20 position or angle. Such means for adjusting the camera orientation 20 include a gear assembly 34 having a motor inoperably connected with camera 20 so as to control the pan and tilt of the camera 20. Pan and tilt camera mounts, such as the Bescor MC 101 motorized pan head, or the like, may be used. Typically, the pan and tilt gear assembly 34 and camera 20 are mounted on a platform 36 for secure attachment to the framework 14. Typically, the platform 36 is adjustable along in height along the mast 18 of the framework 14. This pan tilt camera mount 34 would be activated and controlled by the controller 22 based upon signals received from the user command center 12. Thus, the camera 20 orientation can be changed to meet the positions of sporting event participants along the course or field or track thereof, to take into account the changing path taken by event participants over the course of the sporting event, or for whatever other reason deemed necessary by the operator of the user command center 12. The remote camera module 10 also contains a camera trigger transceiver 46 which is typically attached to camera 20. A latch switch 48 is interposed between the camera trigger transceiver 46 and the camera 20. The latch switch's 48 function is controlled by the controller 22 via an electrical connection between the latch switch 48 and controller 22.

The computer of the controller 22 preferably includes an operating system, such as WinXP that stores pictures taken, as well as a parallel port controller, such as Lalim Parallel Port Controller and camera control software such as Nikon Capture which allows realtime camera adjustment. The computer also includes software which allows remote access, such as PC Anywhere.

As the remote camera modules 10 are typically used outdoors, they include means for protecting the critical electronic components from damage by the weather, such as during a rain storm. In the embodiment illustrated in FIG. 2, such means typically comprises a sun/rain cover 38, which can be in the form a sheet of plastic or fabric that repels moisture and protects the sensitive electronic components from excessive sunlight. Of course, an opening would be provided for the camera 22 to take pictures. The framework 14 illustrated in FIG. 2 is particularly suited for accommodating such a weather cover 38.

However, it will be appreciated by those skilled in the art that the framework 14 illustrated in FIG. 2 and described above is merely a preferred embodiment used in stand-alone applications along a roadside or the like. Other framework or fastening means are contemplated and within the scope of the present invention. For example, in some instances, it may be desirable to mount the camera 20 onto the framework of the finish line banner of a race, on a building or utility pole in a city environment. In such cases, the controller 22 will still be electrically connected to the camera 20 and tilt gear assembly 34 and any sort of weather protection means could be devised for covering and otherwise protecting the electronic equipment.

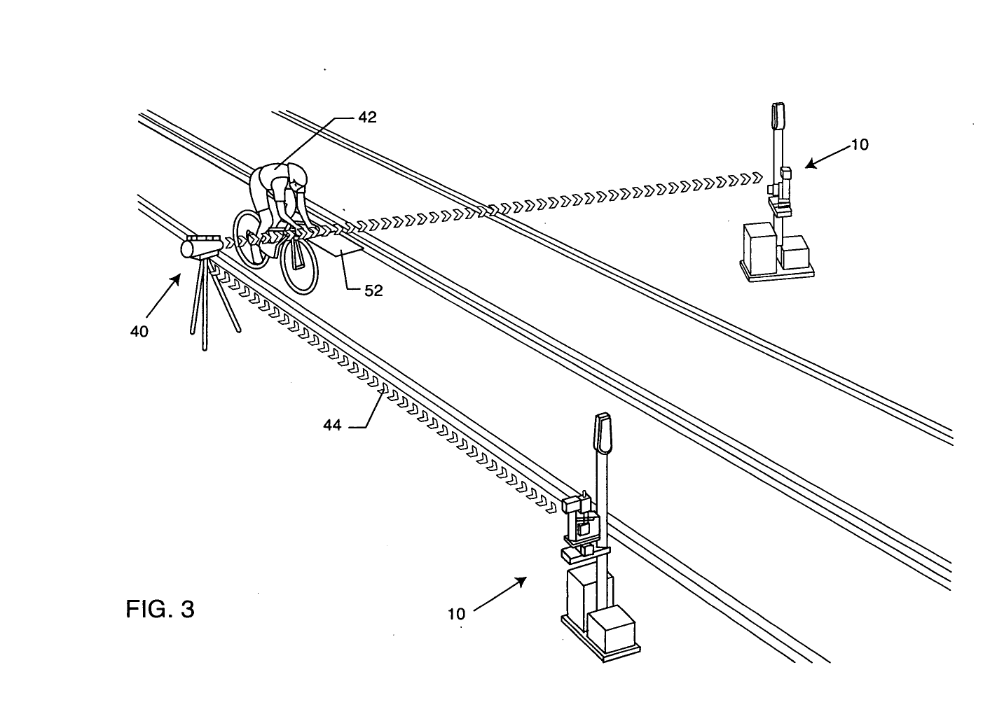

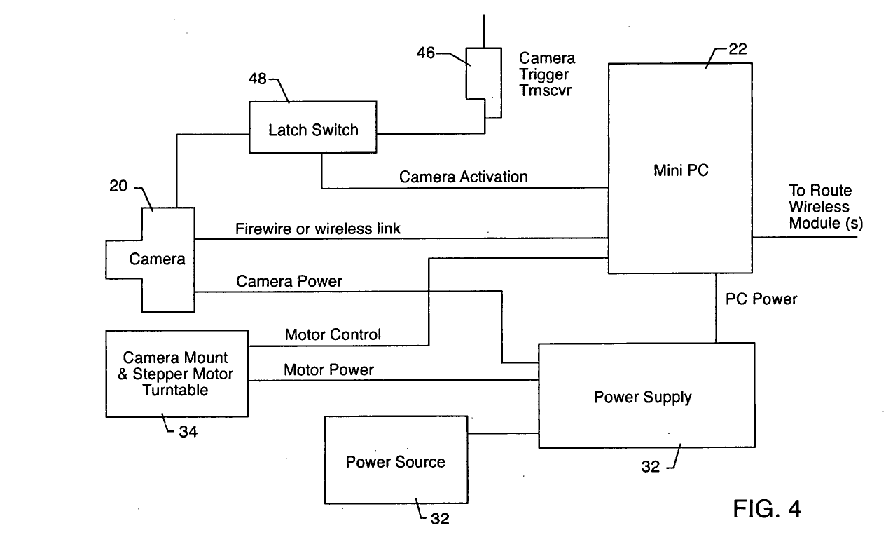

With reference now to FIGS. 3 and 4, at least one remote camera module 10 is placed along a strategic location of the course or field of the sporting event. A sensor/trigger device determines when a sporting event participant 42 passes within the proper distance to the remote camera module 10. The sensor/trigger device 40 relays a signal 44 to the one or more remote camera modules 10 having a transceiver 46 in electronic communication with the camera so that the camera 20 is triggered to take a photograph of the event participant 42. As illustrated in FIG. 4, the camera trigger transceiver 46 is in electronic communication with a latch switch 48 which is in electronic communication with both the computer controller 22 and camera 20 for taking the picture. Computer controller 22 is capable of turning latch switch 48 on or off which will either allow or prevent camera trigger transceiver 46 from triggering the camera 20. Controlling latch switch 48 via controller 22 and ultimately via controller computer 58 is desirable to prevent camera 20 from taking pictures of uninteresting subjects such as event spectators, support personnel, or unrelated objects such as passing cars along the course route. In some instances, the sensor/trigger device 40 is operably connected to a flash/strobe device 50 for illuminating the area surrounding the event participant 42 to enhance the quality of the photograph. Of course, such flash/strobe device 50 can also be incorporated into each remote camera module 10 or the separate components activatable by either the sensor/trigger device 40 or the user command center 12 or even the controller of the remote camera module 10. Typically, the flash/strobe device is free standing and in communication with the remote camera module 10 so as to be synchronized with the camera 20.

In a particularly preferred embodiment sensor/trigger device 40 comprises a light-activated triggering device such that when the sporting event participant passes between the triggering device and a mat 52, such as a reflective mat or a black felt mat, the triggering device 40 is activated. As such, the triggering device comprises a light-impermeable housing having a polarizing light filter iris or similar light limiting device positioned within the housing, a lens disposed within the housing for focusing light into a transducer, wherein a passive trigger signal is generated when light is reflected into the photosensor or upon disruption of received light an active trigger signal is generated. Such a sensor/trigger device 40 is the subject of U.S. Pat. No. 6,768,094 in the name of the present inventor (and hereby incorporated by reference). Of course, other sensor/triggering devices could be utilized as well, such as the breaking of a light beam or detection of the event participant using other signals or the like. Such triggering methods can include active and passive devices as are the subject of U.S. patent application Ser. No. 09/641,248, filed Aug. 17, 2000 and U.S. Provisional Application No. 60/163,879, filed Nov. 5, 1999 in the name of the present inventor (and hereby incorporated by reference). The camera 20 of the remote control modules 10 can be focused upon the area where the sporting event participant 42 will trigger the sensor 40. As temperatures rise throughout the day or due to mechanical vibrations, such focus may need to be altered by the user command center 12.

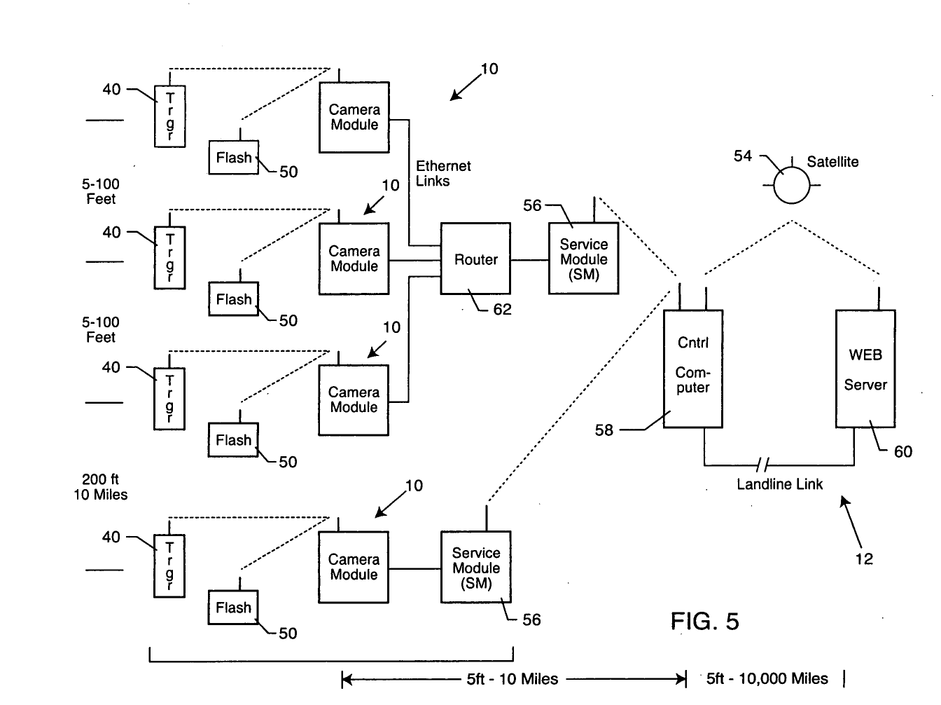

With reference now to FIG. 5 a diagram illustrates the interconnection of the user command center 12 with a plurality of camera modules 10 via a satellite 54 or the like so as to be wireless. In this instance service module 56 receives the wireless command from the user command central computer 58. The user central command computer 58 is preferably linked to a web server 60. In the case that multiple remote camera modules 10 are linked together with ethernet links, a router or switch 62 is linked between the camera modules and the service modules 56. As can be seen in FIG. 5, the camera modules can be only a few feet away from one another or the central command center 12, or separated by many miles. Nonetheless, once the remote camera modules are positioned and placed in electronic communication with the user command center 12, a single operator can control the photography of an entire event over many miles. Preferably, the remote camera modules periodically send sample pictures to the command center 12 for viewing by the operator. As many pictures may be taken in a relatively short time-frame, preferably, these images are screen images or thumb nail images so as to contain less data and the transfer be quickly transferred via the wireless link. The operator, upon viewing the screen or thumb nail images (which may have a resolution of 500 pixels versus 3.5M pixels or more of the actual photograph), can determine if the cameras of the respective camera modules 10 are in focus, properly orientated, etc. and make the necessary adjustments to each camera module 10 as necessary.

As current digital camera storage devices are fairly limited in the number of pictures that can be stored, the cameras 20 preferably transfer the images into a buffer or storage medium having a much greater storage capacity. Such storage medium may be within the computer of the controller 22 for later retrieval. Conceivably, the image files could be wirelessly downloaded to remote storage mediums, such as the central controller computer 58 or web server 60.

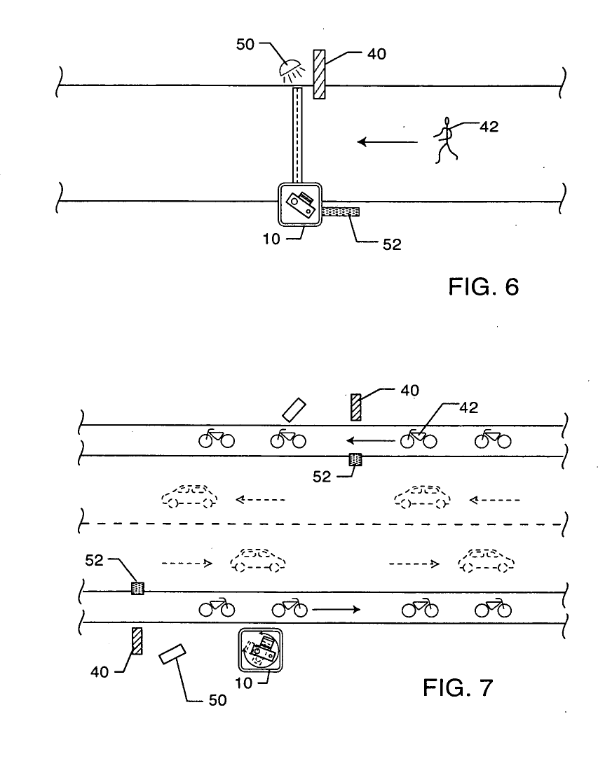

With reference now to FIGS. 6 and 7, a single remote camera module 10 may be placed with a trigger device 40 and flash 50 at a finish line or the like of a race so as to capture the event participants 42 as they pass the finish line. However, as illustrated in FIG. 7, a single remote camera module 10 may be capable of being used for capturing photos of event participants 42 as they pass different positions of the event course. For example, due to the fact that camera 20 can be orientated in different directions, as the cyclists in this case pass a first side of the road the camera can be positioned so as to take the picture of the cyclist in this direction. If the course loops such that the cyclists return on the opposite side of the road, the camera 20 of the remote camera module 10 can be reoriented so as to be triggered by a sensor/trigger device 40 on the opposite side of the road to capture photographs from a different perspective. Of course, as described above, the camera 20 can be positioned on other framework, tripods, buildings, etc. to capture the necessary photographs while still implementing the teachings of the present invention.

As discussed above, the photographic digital images are stored within a storage medium, either at the camera module 10 itself, or automatically downloaded in real time to a computer or web server 58 or 60. In a particularly preferred embodiment, the digital images of each photograph are associated with indicia which can later be searched on a web-site by the event participants to find his or her photograph for that particular event. Such a process is described in detail in U.S. application Ser. No. 09/641,248 filed Aug. 17, 2000, which is incorporated herein by reference. In a particularly preferred embodiment, the digital images each include a time and date indicia when the photograph was taken. A participant of the sporting event can subsequently log onto a web-site and use the approximate or exact date and time when the photograph was taken to search for his or her photograph. Other data, such as a participant's bib number, a code extracted from a passive or active device worn by the event participant, etc. to be used in association with the photograph for later searching.

The identifying data assigned to each photograph is posted so as to be readily available to the participants of the event. The photographs are then transferred to the computer network server where they are cataloged according to the identifying data.

One interested in viewing photographs of the event can access the computer network server and search for a particular photograph utilizing the identifying data. In the event the participant is using time as the identifying date and this time is not known, a particular photograph can be searched using the approximate time it was taken. The approximate time can be calculated according to various estimating algorithms. One such preferred algorithm has the following formula Tₚ=(Lₚ/L_{c})(Tf), wherein Lₚ equals the distance from a starting point of the event to the photographer, Tₚ equals the minutes from the starting point of the event to the photographer, Tₚ equals the minutes from the starting point to a photographer at location Lₚ, L_{c} equals the total distance of the event, and Tf equals the total minutes to finish the event by the participant.

After searching, the particular photograph is displayed for inspection. The photograph may be ordered on-line. The order is fulfilled by sending the photograph to the person ordering. This is done by electronically transmitting the photograph, preferably via e-mail, allowing the person who has logged onto the computer network to print the photograph onto his or her printer, or the photograph is printed and subsequently mailed by the computer network server host utilizing information provided by the person ordering the photograph.

In this manner, the event participant can find his or her photograph within a few days after the event, and order it on-line, resulting in the event participant receiving his or her photograph faster than prior art methodology and at much less expense to the photographer.

It will be appreciated by those skilled in the art that the present invention dramatically reduces the cost associated with taking photographs of a sporting event by reducing the number of photographers and assistants, or in some cases completely eliminating them. Human error arising from taking hundreds or thousands of pictures over a prolonged period of time is also avoided. Moreover, sporting event participants are able to easily and quickly find and order their event photographs.

Although several embodiments have been described in detail for purposes of illustration, various modifications may be made without departing from the scope and spirit of the invention. Accordingly the invention is not to be limited, except as to by the appended claims.

1. An automated camera system for use during a sporting event, the system comprising:
a user command center; and
a remote camera module positioned along a course or field of the sporting event and in electronic communication with the command center, the remote camera module comprising a still photograph camera, a device for triggering the camera, and a controller for adjusting camera optical characteristics based on commands received from the user command center.

2. The system of claim 1, wherein the controller comprises a computer.

3. The system of claim 1, wherein the remote camera module further comprises means for communicating with the command center, including an antenna operably connected to the controller.

4. The system of claim 1, wherein the remote camera module includes means for adjusting orientation of the camera.

5. The system of claim 4, wherein the adjustment means includes a motor for adjusting the camera orientation.

6. The system of claim 5, including a gear assembly operably connected to the motor for adjusting the camera orientation.

7. The system of claim 1, wherein the controller is adapted to control at least one of: an f-stop, an angle, a focus, zoom, and a shutter speed of the camera.

8. The system of claim 1, wherein the remote camera module includes a power source.

9. The system of claim 8, wherein the power source comprises a battery.

10. The system of claim 1, wherein the camera comprises a digital camera.

11. The system of claim 10, wherein the remote camera module includes an electronic storage medium for storing digital images from the camera.

12. The system of claim 11, wherein the digital images each include a date and time indicia.

13. The system of claim 12, including the steps of downloading the digital images to a web-site, and searching the digital images on the web-site according to the date and time indicia.

14. The system of claim 1, wherein the remote camera module includes a flash device, and wherein the triggering device activates the flash device and the camera.

15. The system of claim 1, wherein the triggering device is light activated or by active or passive electronic components.

16. The system of claim 15, wherein the triggering device comprises a light-impermeable housing having a polarizing light filter or iris positioned within the housing, a lens disposed in the housing for focusing light onto a transducer, wherein a passive trigger signal is generated when light is reflected into the photosensor, and upon disruption of received light an active trigger signal is generated.

17. The system of claim 1, wherein the remote camera module includes means for protecting electronic components thereof from ambient environmental conditions.

18. The system of claim 1, wherein a plurality of remote camera modules are positioned in spaced apart relation along the sporting event course or field.

19. An automated camera system for use during a sporting event, the system comprising:
a plurality of remote camera modules positioned along a course or field of the sporting event, each remote camera module comprising a digital still photograph camera, a sensor device for triggering the camera, and an electronic storage medium for storing digital images from the camera.

20. The system of claim 19, wherein each remote camera module is in electronic communication with a user command center, and wherein each remote camera module includes a controller for adjusting camera orientation or optical characteristics based on commands received from the user command center.

21. The system of claim 20, wherein the controller comprises a computer.

22. The system of claim 20, wherein the remote camera module further comprises means for communicating with the command center, including an antenna operably connected to the controller.

23. The system of claim 20, wherein the remote camera module includes means for adjusting orientation of the camera.

24. The system of claim 23, wherein the adjustment means includes a motor for adjusting the camera orientation.

25. The system of claim 24, including a gear assembly operably connected to the motor for adjusting the camera orientation.

26. The system of claim 20, wherein the controller is adapted to control at least one of: an f-stop, an angle, a focus, zoom, and a shutter speed of the camera.

27. The system of claim 19, wherein the remote camera module includes a power source.

28. The system of claim 27, wherein the power source comprises a battery.

29. The system of claim 19, wherein the digital images each include a date and time indicia.

30. The system of claim 29, including the steps of downloading the digital images to a web-site, and searching the digital images on the web-site according to the date and time indicia.

31. The system of claim 19, wherein the remote camera module includes a flash device, and wherein the triggering device activates the flash device and the camera.

32. The system of claim 19, wherein the triggering device is light activated by active or passive electronic components.

33. The system of claim 32, wherein the triggering device comprises a light-impermeable housing having a polarizing light filter positioned within the housing, a lens disposed in the housing for focusing light onto a transducer, wherein a passive trigger signal is generated when light is reflected into the photosensor, and upon disruption of received light an active trigger signal is generated.

34. The system of claim 19, wherein the remote camera module includes means for protecting electronic components thereof from ambient environmental conditions.

35. An automated camera system for use during a sporting event, the system comprising:
a user command center;
a plurality of remote camera modules positioned along a course or field of the sporting event, each remote camera module comprising a digital still photograph camera, a sensor device for triggering the camera, an electronic storage medium for storing digital images from the camera, a controller for adjusting camera optical characteristics or orientation based on commands received from the user command center, means for adjusting orientation of the camera, and a power source.

36. The system of claim 35, wherein the controller comprises a computer.

37. The system of claim 35, wherein the remote camera module further comprises means for communicating with the command center, including an antenna operably connected to the controller.

38. The system of claim 35, wherein the adjustment means includes a gear assembly operably connected to a motor for adjusting the camera orientation.

39. The system of claim 35, wherein the controller is adapted to control at least one of: an f-stop, an angle, a focus, zoom, and a shutter speed of the camera.

40. The system of claim 35, wherein the power source comprises a battery.

41. The system of claim 35, wherein the digital images each include a date and time indicia, and wherein the digital images are downloaded to a web-site for searching on the web-site according to the date and time indicia.

42. The system of claim 35, wherein the remote camera module includes a flash device, and wherein the triggering device activates the flash device and the camera.

43. The system of claim 35, wherein the triggering device is light activated or by active or passive electronic components.

44. The system of claim 43, wherein the triggering device comprises a light-impermeable housing having a polarizing light filter positioned within the housing, a lens disposed in the housing for focusing light onto a transducer, wherein a passive trigger signal is generated when light is reflected into the photosensor, and upon disruption of received light an active trigger signal is generated.

45. The system of claim 35, wherein the remote camera module includes means for protecting electronic components thereof from ambient environmental conditions.
